(19) United States
(12) Patent Application Publication
(10) Pub. No.: US 2019/0249854 A1
(43) Pub. Date: Aug. 15, 2019

(54) Rail Structure And Rail Lighting Structure

(71) Applicant: GIOTTO'S IND.INC., Shenzhen (CN)

(72) Inventor: Weihong Shen, Shenzhen (CN)

(73) Assignee: GIOTTO'S IND.INC., Shenzhen (CN)

(21) Appl. No.: 16/246,623

(22) Filed: Jan. 14, 2019

(30) Foreign Application Priority Data
Feb. 11, 2018 (CN) 201820246501.1
Feb. 11, 2018 (CN) 201820247195.3
Apr. 23, 2018 (CN) 201810365805.4
Apr. 23, 2018 (CN) 201820578765.7

(51) Int. Cl. F21V 23/06; F21V 15/015; F21V 17/06; F21V 8/00; F21V 23/04; F21V 23/00

(52) U.S. Cl. CPC F21V 23/06; F21V 15/015; F21V 17/06; F21Y 2103/10; F21V 23/04; F21V 23/0435; F21V 23/009; G02B 6/0088

(57) ABSTRACT

The present disclosure relates to a rail structure and a rail lighting structure. The rail structure includes a rail; the rail includes a body and a light outgoing area formed by the body; the body further defines an opening position in communication with the light outgoing area, and the opening position is located at a light emitting direction of the light outgoing area; the body has an extending end located at the opening position, and the extending end is configured to fix a light guide plate; the body defines a light source mounting position, the light source mounting position is adjacent to the light outgoing area, and is configured to mount a light source.

### CROSS-REFERENCE TO RELATED APPLICATIONS

This application claims the benefit of Chinese Patent Application No. 2018202465011, filed Feb. 11, 2018, Chinese Patent Application No. 2018202471953, filed Feb. 11, 2018, Chinese Patent Application No. 2018205787657, filed Apr. 23, 2018, and Chinese Patent Application No. 2018103658054, filed Apr. 23, 2018. The disclosures of the above identified applications are hereby incorporated herein in their entireties by reference.

### TECHNICAL FIELD

The present disclosure relates to the field of rail lighting, and particularly relates to a rail structure and a rail lighting structure.

### BACKGROUND

Generally, a rail lighting structure is a lighting device with a rail, such as a LED rail light. LED rail light, also known as LED track light, is a rail light with a LED as a light source, it is a kind of track light and is widely used in lighting places such as shopping mall, car exhibition, jewelry, starred hotel, boutique clothing, high-end club, museum, chain stores, business office, window display, and counter. It is an ideal light source to replace the conventional tungsten halogen light and the metal halide light. Comparing a LED rail light with a conventional metal halide light with the same brightness, the electricity consumption of the LED rail light is only 40%-60% of that of the conventional metal halide light. Moreover, the working life of the LED rail light can be at least 30,000 hours, while the working life of the conventional metal halide light is generally 8,000 hours, which shows the advantages of LED rail light. With the continuous development of electronic technology, new styles on the market emerge in an endless stream, with different shapes and flexibility. It can be understood that the LED rail light is only one type of rail lighting structure, and the rail lighting structure also includes other lighting devices with rails.

The rail lighting structure mainly includes a rail structure and a lighting structure. The conventional rail lighting structure has some problems such as having a constant length, being difficult to mount the rail structure, particularly being difficult to connect the rail and mount the lighting structure, and the dazzling glare from the lighting structure.

### SUMMARY

According to various embodiments of present disclosure, a rail structure and a rail lighting structure is provided.

A rail structure includes a rail; the rail includes a body and a light outgoing area formed by the body. The body further defines an opening position in communication with the light outgoing area, and the opening position is located at a light emitting direction of the light outgoing area; the body has an extending end located at the opening position, and the extending end is configured to fix a light guide plate. The body defines a light source mounting position, the light source mounting position is adjacent to the light outgoing area and is used to mount a light source.

A rail lighting structure includes a conductive input connector, a connecting body, a conductive switch, a rail, a light source, and a light guide plate. The rail has a body and a light outgoing area formed by the body. The body further defines an opening position in communication with the light outgoing area, and the opening position is located at a light emitting direction of the light outgoing area, the light guide plate is located in the body and covers the opening position; the light source is located in the body, and the light source emits light towards the light outgoing area and the opening position. The connecting body comprises a first connecting body and a second connecting body, the first connecting body and the second connecting body are both located on the body and are electrically coupled to an anode circuit and a cathode circuit, respectively; the conductive input connector is partially inserted into the body, and comprises a connecting portion, the connecting portion comprises a first connecting portion and a second connecting portion, the first connecting portion abuts against the first connecting body, and the second connecting portion abuts against the second connecting body. The conductive switch comprises a connecting end, the connecting end comprises a first connecting end and a second connecting end, the first connecting end is connected to the first connecting body, and the second connecting end is connected to the second connecting body.

The details of one or more embodiments of the present disclosure are set forth in the accompanying drawings and the description below. Other features, objects, and advantages of the invention will be apparent from the description and drawings, and from the claims.

### BRIEF DESCRIPTION OF THE DRAWINGS

To illustrate the technical solutions according to the embodiments of the present disclosure or in the prior art more clearly, the accompanying drawings for describing the embodiments or the prior art are introduced briefly in the following. Apparently, the accompanying drawings in the following description are only some embodiments of the present disclosure, and persons of ordinary skill in the art can derive other drawings from the accompanying drawings without creative efforts.

FIG. 1 is a perspective view of a rail lighting structure according to an embodiment.

FIG. 2 is a perspective exploded view of the rail lighting structure in FIG. 1.

FIG. 3 is a partial enlarged view of the rail lighting structure in FIG. 2.

FIG. 4 is a bottom view of the rail lighting structure in FIG. 1.

FIG. 5 is a cross-sectional view taken along line A-A of FIG. 4.

FIG. 6 is a cross-sectional view of a rail structure according to an embodiment.

FIG. 7 to FIG. 10 are different views of a conductive switch of a rail lighting structure according to an embodiment.

FIG. 11 to FIG. 14 are different views of conductive switch of a rail lighting structure according to another embodiment.

FIG. 15 to FIG. 16 are a different views of a light guide plate of a rail lighting structure according to an embodiment.

FIG. 17 to FIG. 18 are a different views of a light guide plate of a rail lighting structure according to another embodiment.

FIG. 19 to FIG. 20 are a different views of a light guide plate of a rail lighting structure according to another embodiment.

FIG. 21 to FIG. 22 are different views of a light guide plate of a rail lighting structure according to yet another embodiment.

FIG. 23 is a perspective view of a rail lighting structure according to another embodiment.

FIG. 24 is a perspective exploded view of the rail lighting structure in FIG. 23.

FIG. 25 is a perspective view of a rail lighting structure according to another embodiment.

FIG. 26 is an exploded view of the rail lighting structure in FIG. 25.

FIG. 27 is a view of the rail lighting structure in FIG. 25.

FIG. 28 is a cross-sectional view taken along line A-A of FIG. 27.

FIG. 29 is a perspective view of a rail lighting structure according to another embodiment.

FIG. 30 is a perspective exploded view of the rail lighting structure in FIG. 29.

FIG. 31 is a cross-sectional view of a rail structure according to another embodiment.

FIG. 32 is a side view of a lampshade ring unit of the rail structure according to another embodiment.

FIG. 33 is a side view of the taper and angle of the lampshade ring unit of the rail structure according to another embodiment.

FIG. 34 is a side view of a linear lampshade formed by a plurality of regularly arranged lampshade ring units of the rail structure according to another embodiment.

FIG. 35 is a front view of a lampshade ring unit of the rail structure according to another embodiment.

FIG. 36 is a front view of a lampshade ring unit of the rail structure according to another embodiment.

FIG. 37 is a perspective view of a lampshade ring unit of the rail structure according to yet another embodiment.

### DETAILED DESCRIPTION OF THE EMBODIMENTS

The above objects, features and advantages of the present disclosure will become more apparent by describing in detail embodiments thereof with reference to the accompanying drawings. The following description provides specific details for a thorough understanding of the present disclosure. However, the present disclosure can be implemented in many other ways than those described herein, and those skilled in the art can make similar modifications without departing from the scope of the present disclosure, and thus the present disclosure is not limited by the specific embodiments disclosed below.

It will be understood that when an element is referred to as being “fixed” to another element, it can be directly fixed to the other element or intervening elements may be present. Also, when an element is referred to as being “connected” or “coupled” to another element, it can be directly connected or coupled to the other element or intervening elements may be present. As used herein, the terms “vertical”, “horizontal”, “left”, “right” and the like are merely for the illustrative purpose.

Unless otherwise defined, all terms (including technical and scientific terms) used herein have the same meaning as commonly understood by one of ordinary skill in the art to which this invention belongs. The terms used herein is for the purpose of describing particular embodiments only and is not intended to limit the present disclosure. As used herein, the term “and/or” includes any and all combinations of one or more of the associated listed items.

According one of the embodiments, a rail structure includes a rail; the rail has a body and a light outgoing area formed by the body. The rail further defines an opening position in communication with the light outgoing area, and the opening position is located at a light emitting direction of the light outgoing area; the body has an extending end located at the opening position, and the extending end is configured to fix a light guide plate; the body defines a light source mounting position, the light source mounting position is adjacent to the light outgoing area, and is used to mount a light source. According to the aforementioned rail structure, the length of the rail can be flexibly designed according to demands, the rail can be relatively long, or can be a standard component. The connection of the rail and the mounting of the light source are easy to be achieved, the light source is easy to be mounted in the body and emit light through the light outgoing area, and the light scattering can be achieved by an light guide plate, so as to solve the problem of the conventional rail lighting structure that the light is too dazzling.

According to another embodiment, a rail lighting structure includes a conductive input connector, a connecting body, a conductive switch, a rail, a light source, and a light guide plate. The rail has a body and a light outgoing area formed by the body. The body further defines an opening position in communication with the light outgoing area, and the opening position is located at a light emitting direction of the light outgoing area, the light guide plate is located in the body and covers the opening position. The light source is located on the body, and a light emitting direction of the light source is facing the light outgoing area and the opening position. The connecting body includes a first connecting body and a second connecting body, the first connecting body and the second connecting body are both located on the body and are electrically coupled to an anode circuit and a cathode circuit, respectively. The conductive input connector is partially inserted into the body, and includes a connecting portion, the connecting portion includes a first connecting portion and a second connecting portion. The first connecting portion abuts against the first connecting body, and the second connecting portion abuts against the second connecting body; the conductive switch includes a connecting end. The connecting end includes a first connecting end and a second connecting end, the first connecting end is connected to the first connecting body, and the second connecting end is connected to the second connecting body. According to the aforementioned rail lighting structure, an easy-to-connect rail lighting circuit is achieved by designing the connecting body, the conductive input connector, and the conductive switch, and the length of the rail lighting circuit can be relatively long, or can be of a standard component. The light source is easy to be mounted in the body and emit light through the light outgoing area, and the light scattering can be achieved by an engagement with the light guide plate, so as to solve the problem of the conventional rail lighting structure that the light is too dazzling. In one of the embodiments, a rail lighting structure includes a conductive input connector, a connecting body, a conductive switch, a rail, a light source, and a light guide plate.

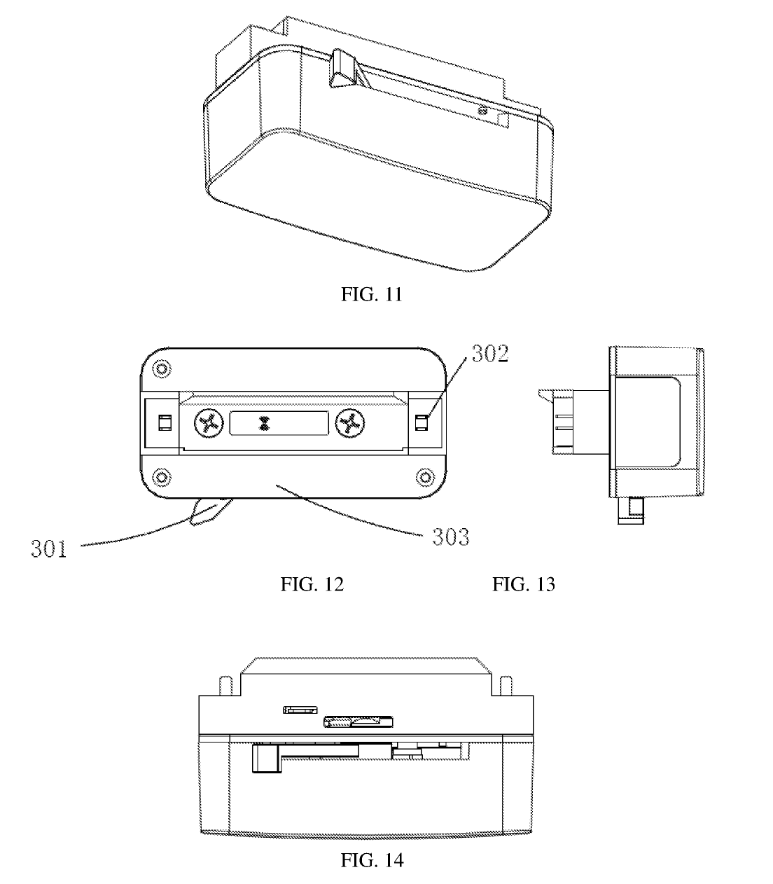

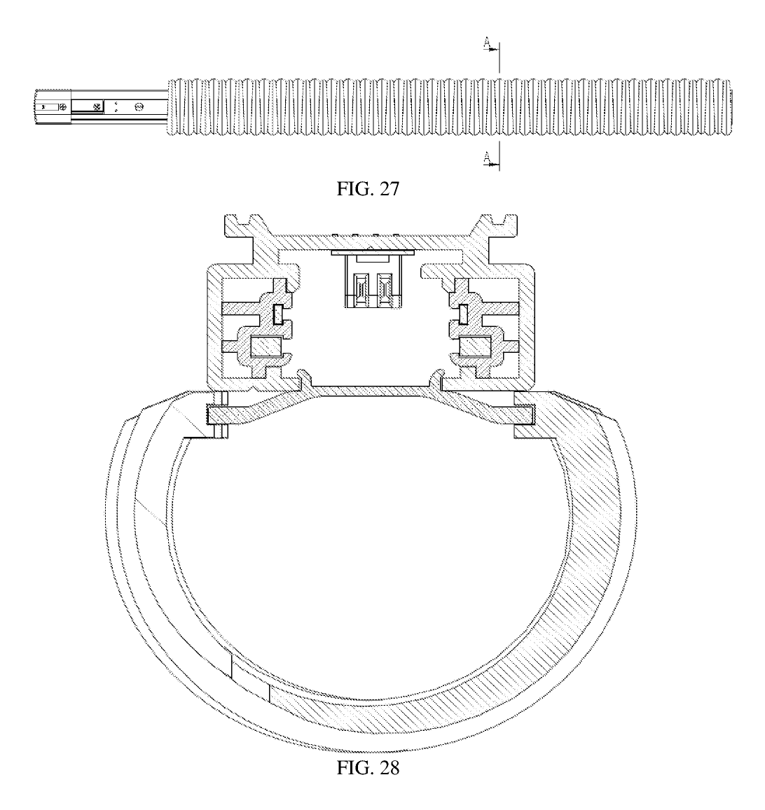

It should be understood that, the light source of each of the embodiments is an illumination light source. The rail of the rail lighting structure of each of the embodiments is the same as or different from the rail of the rail structure of each of the embodiments. The rail lighting structure and the rail structure of each of the embodiments can have same parts of structure; the rail lighting structure can include a rail structure of any one of the embodiments. The rail structure can be implemented by parts of structures from partial or total drawings in FIG. 1 to FIG. 31.

In one of the embodiments, the rail has a body and a light outgoing area formed by the body. The light outgoing area is a space formed by the body, and the light form the light source inside the body emits out from the body through the light outgoing area. The body can be made of a plastic, an aluminum alloy, a stainless steel, or the like. In one of the embodiments, the body is an aluminum profile, and a first connecting body and a second connecting body are both insulated from the body. In addition, the rail is provided with two rail mounting portions extending outwardly therefrom, and each of the rail mounting portions defines a groove area with other portions of the body. The two rail mounting portions and the groove area thereof are cooperatively engaged to mount the rail or the body. In one of the embodiments, the rail mounting portion is provided with a first protrusion and a second protrusion, and a recessed area is defined between the first protrusion and the second protrusion. The first and second protrusions and the recessed area are engaged to achieve a stable mounting effect, which is particularly suitable for inserting the rail or the body to an external position for rail mounting.

In each of the embodiments, the body further defines an opening position in communication with the light outgoing area, and the opening position is located at a light emitting direction of the light outgoing area. The body has an extending end located at the opening position, and the extending end is configured to fix a light guide plate. The body defines a light source mounting position, the light source mounting position is adjacent to the light outgoing area, and is used to mount a light source. In one of the embodiments, the light source mounting position is used to mount the light source and ensures that the light source emits light towards the light outgoing area and the opening position. In one of the embodiments, the light source is located in the body, and emits light source towards the light outgoing area and the opening position. Specifically, the light source is located inside the body, and the light emitting direction of the light source is facing the light outgoing area and the opening position. In one of the embodiments, the light source is mounted on the light source mounting position. The light outgoing area is in communication with the opening position, or the opening position is a part of the light outgoing area. The light source emits light towards the light outgoing area and the opening position, and the light emits out from the body through the light guide plate that covers the opening position. In addition, the light source includes a PCB and at least one LED located on the PCB, and a drive module thereof. In one of the embodiments, the light source is adhered, screwed, snapped, slidably inserted, or hung on the light source mounting position.

In one of the embodiments, the rail further includes the connecting body. The connecting body includes a first connecting body and a second connecting body, i.e., the rail of the rail structure or the rail lighting structure includes two connecting bodies. The first connecting body and the second connecting body are both located on the body and are electrically coupled to an anode circuit and a cathode circuit, respectively. In one of the embodiments, the first connecting body and the second connecting body are both inserted on the body. In one of the embodiments, the number of the first and the second connecting body are both two, and each side of two inner sides of the body is provided with a set of the connecting body, each set of the connecting body includes one first connecting body and one second connecting body. In one of the embodiments, the first connecting body and the second connecting body are both inserted on the body. In one of the embodiments, the rail further has a first mounting area and a second mounting area formed by the body, respectively. In one of the embodiments, the rail further has a first mounting area and a second mounting area formed by the body, respectively. At least two first protruding portions are extended from the body at the first mounting area, and at least two second protruding portions are extended from the body at the second mounting area; the first connecting body is located at the first mounting area and abuts against the at least two first protruding portions, and the second connecting body is located at the second mounting area and abuts against the at least two second protruding portions; and the first mounting area and the second mounting area are in communication with the light outgoing area, respectively. In one of the embodiments, the first protruding portion and the second protruding portion are both elongated, and extending directions of the first protruding portion and the second protruding portion are the same as an extending direction of the rail; i.e., the extending directions of the first and the second protruding portion are both parallel to the extending direction of the rail. In one of the embodiments, the first connecting body includes a first insulating abutting portion and a first conductor, the first insulating abutting portion defines a first mounting groove, and an extending direction of the first mounting area is the same as the extending direction of the rail, the first insulating abutting portion is located at the first mounting area and abuts against the at least two first protruding portions, the first conductor is located in the first mounting groove and is partially exposed outside the first mounting groove, and an extending direction of the exposed portion of the first conductor is the same as the extending direction of the rail. The second connecting body includes a second insulating abutting portion and a second conductor, the second insulating abutting portion defines a second mounting groove, and an extending direction of the second mounting area is the same as the extending direction of the rail, the second insulating abutting portion is located at the second mounting area and abuts against the at least two second protruding portions, the second conductor is located in the second mounting groove and is partially exposed outside the second mounting groove, and an extending direction of the exposed portion of the second conductor is the same as the extending direction of the rail. That is to say, the first insulating abutting portion is located in the first mounting area and the second insulating abutting portion is located in the second mounting area. In one of the embodiments, the first insulating abutting portion buts against the body and defines at least two gap areas with the body at the first mounting area, and the second insulating abutting portion buts against the body and defines at least two gap areas with the body at the second mounting area. In addition, in one of the embodiments, the first connecting body includes two first conductors that insulated from each other, and the second connecting body includes two second conductors that insulated from each other, each of the connecting ends has two power receiving portions, and the power receiving portions of one connecting end are coupled to the two first conductors, respectively, and the power receiving portions of the other connecting end are coupled to the two first conductors, respectively. In this way, four electrical signals can be controlled using four conductors. In one of the embodiments, the first insulating abutting portion buts against the body and defines at least two gap areas with the body at the first mounting area, and the second insulating abutting portion buts against the body and defines at least two gap areas with the body at the second mounting area. In each of the embodiments, each of the first and second insulating abutting portion is insulating.

Moreover, in one of the embodiments, the rail structure and/or the rail lighting structure includes the light guide plate located on the body and covering the opening position. In one of the embodiments, the light guide plate is fixed to the body via the extending end, and covers the opening position. In one of the embodiments, the light guide plate includes a light guide body and two sliding grooves defined on the light guide body, and the light guide plate is provided on the body via the two sliding grooves and covers the opening position. In one of the embodiments, the light guide body has a light outgoing flat surface, a light outgoing curved surface, or a light composite surface; the light composite surface is formed by at least two light outgoing curved surfaces, formed by at least two light outgoing curved surfaces, or formed by at least one light exiting and at least one light outgoing curved surface. In one of the embodiments, extending end portions are extended outwardly from a side of the light guide body away from the rail, respectively. In one of the embodiments, the two sliding grooves includes a first sliding groove and a second sliding groove. In one of the embodiments, the sliding groove can also be called fastening groove, which is used to slide in one direction and fasten in other directions, so as to prevent from falling off. In one of the embodiments, the rail structure and/or the rail lighting structure includes the light guide plate located on the body and covering the opening position. The light guide plate includes a light guide body and two sliding grooves defined on the light guide body, and the light guide plate is provided on the body via the two sliding grooves and covers the opening position. The light guide body has a light outgoing flat surface, a light outgoing curved surface, or a light composite surface; the light composite surface is formed by at least two light outgoing curved surfaces, formed by at least two light outgoing curved surfaces, or formed by at least one light exiting and at least one light outgoing curved surface. Extending end portions are extended outwardly from a side of the light guide body away from the rail, respectively. In one of the embodiments, the body further defines an opening position in communication with the light outgoing area, and the opening position is located at a light emitting direction of the light outgoing area, the light guide plate is located on the body and covers the opening position; and the light form the light source inside the body emits out from the light outgoing area through the light guide plate. In this way, the light guide plate can not only achieve a better scattering effect, but also play a role of dust shielding, and the direction of light exiting is appropriately adjusted by the light composite surface, such that the rail structure or the rail lighting structure has a good dust-proof effect.

In one of the embodiments, the rail structure and/or the rail lighting structure further includes a conductive input connector. The conductive input connector is partially inserted into the body, i.e., a part of the conductive input connector is inserted into the body. The conductive input body includes a connecting portion, the connecting portion includes a first connecting portion and a second connecting portion, the first connecting portion abuts against the first connecting body, and the second connecting portion abuts against the second connecting body. In one of the embodiments, the part of the conductive input connector is inserted at an end of the body, and the other end of the body is sealed. In this way, a nearly sealed environment is formed in the rail and the body thereof, so as to prevent the rail from water and bugs, and to achieve a better dust-proof effect. With the body made of the aluminum profile, the heat dissipation problem can be basically solved and the dust-proof effect can be basically achieved, and the embodiment is suitable for both indoor and outdoor application.

In one of the embodiments, the rail structure or the rail lighting structure further includes a plurality of lampshade ring units detachably provided on the body. In one of the embodiments, the rail structure or the rail lighting structure further includes the light guide plate, and the lampshade ring units are detachably provided on the light guide plate. In one of the embodiments, the light guide plate has the light guide body, extending end portions are extended outwardly from a side of the light guide body away from the rail, respectively; and the lampshade ring units are respectively provided on the light guide body, each of the lampshade ring units is detachably provided on the two extending end portions, respectively. In this way, scattering and refraction in more directions can be achieved by the lampshade ring units, and it is convenient to adjust and disassemble the lampshade ring units. In addition, the lampshade ring units are regularly arranged to form a linear lampshade that matches the body or the light guide plate. In each of the lampshade ring units, the lampshade ring unit includes a light-transmitting body and two end portions connected to the light-transmitting body, each of the end portions has a fixing structure, and the two end portions and the light-transmitting body cooperatively forms a partial surrounding structure. In each of the fixing structures, the fixing structure includes a first fixing portion and a second fixing portion, a notch groove is defined between the first and the second fixing portion. The two notch grooves of the lampshade ring unit are used to receive the two opposite extending end portions of the light guide plate, respectively, such that the lampshade ring unit is relatively fixed at the two sides of the light guide plate, and the partial surrounding structure and the light guide body cooperatively form a full surrounding structure. According to the aforementioned rail structure or the rail lighting structure, a plurality of the lampshade ring units are flexibly mounted on the two sides of the light guide plate to form a linear lampshade that matches the light guide plate, such that the mounting of the lampshade ring unit is easy and convenient, and the lampshade ring unit can be easy to be replaced and cleaned; and the identical lampshade ring units are suitable for light guide plates with different lengths, which facilitates to simplifying producing molds and producing materials, improving producing efficiency. Additionally, the lampshade ring unit includes a light-transmitting body and two end portions connected to the light-transmitting body, each of the end portions has a fixing structure, and the two end portions and the light-transmitting body cooperatively forms a partial surrounding structure, the partial surrounding structure is used to form an open-ended opening area. In each of the fixing structures, the fixing structure includes a first fixing portion and a second fixing portion, a notch groove is defined between the first and the second fixing portion; the two notch grooves are symmetric. According to the aforementioned rail structure or the rail lighting structure, a plurality of the lampshade ring units can form a lampshade, such that the mounting of the lampshade ring unit is easy and convenient, and the lampshade ring unit can be easy to be replaced and cleaned; and the identical lampshade ring units are suitable for light guide plates with different lengths, which facilitates to simplifying producing molds and producing materials, improving producing efficiency. In one of the embodiments, the lampshade ring unit is integrally made of light-transmitting plastics, i.e., the lampshade is made of light-transmitting material. Moreover, the light guide plate is a linear light guide plate, i.e., the light guide body is a linear light guide body, in this case, linear light strip, light tube, or light plates can be produced; or the light guide plate is a combination of several light guide plates. In one of the embodiments, the light guide body or the light guide plate is H-shaped, L-shaped, N-shaped, T-shaped, V-shaped, Y-shaped or a combination thereof; thus, various light strips, light tubes, or light plates can be produced. In one of the embodiments, at least one end of the light guide plate is provided with a blocking portion configured to limit the position of the lampshade ring unit. In this way, the lampshade ring unit can be prevented from falling off from the edge of the light guide plate. In one of the embodiments, the blocking portion includes a blocking structure rotatably located on the linear source plate. In one of the embodiments, the linear source plate defines a threaded hole, and the blocking structure is rotatably located in the threaded hole; and in one of the embodiments, one end of the blocking structure is pivoted or shafted to the linear source plate, and the other end blocks the light guide plate at the edge thereof. Furthermore, in each of the embodiments, the lampshade ring unit is provided with a colored layer. Additionally, the lampshade ring units of the linear lampshade has same or different colored layers, such that the lampshades with same or different colors can be produced, so as to achieve same or different illumination effects. Moreover, in each of the embodiments, the lampshade ring unit has a cross section which is fully or partial elliptical, fully or partial circular, or polygonal with 3 or more edges. In one of the embodiments, the cross section of the lampshade ring unit can be conical, square pyramid, diamond, pyramid, or have other irregular shape. In this way, a plurality of refracting light paths can be realized, the multi-color characteristic can be shown, and various lighting ambiances can be achieved. In one of the embodiments, the notch grooves of each lampshade ring units are in the same planer area, and the two extending end portions of the light guide plate are in the same planer area. In one of the embodiments, the notch grooves of each lampshade ring units are in the same curved surface area, and the two extending end portions of the light guide plate are in the same curved surface area. Or it should be understood that the light guide body has a curved structure.

Additionally, in each of the embodiments, the light-transmitting body is provided with an elastic portion. In this way, it is not required to sleeve the lampshade ring unit from the end portion of the light guide plate, and the lampshade ring unit can be directly bent and clasped in the middle for an easy mounting and disassembly. In addition, in each of the embodiments, the light transmitting body and the two end portions are integrally provided, or the light-transmitting body and the two end portions forms an integrally provided acrylic (PMMA) structure. The integrally configuration of the light-transmitting body and the two end portions allows that the production of the lampshade ring unit is easier, and the acrylic structure is advantageous to realize the elasticity of the lampshade ring unit itself. In this way, it is not necessary to sleeve the lampshade ring unit from the end portion of the light guide plate, and the lampshade ring unit can be directly bent and clasped in the middle for an easy mounting and disassembly. Moreover, in each of the embodiments, the partial surrounding structure can be C-shaped, U-shaped, CD-shaped, V-shaped, linear, curved, or of a combined shape thereof. In one of the embodiments, the partial surrounding structure includes a curved shape. It should be understood that, the partial surrounding structure means that comparing with a full surrounding structure, the partial surrounding structure engages with the light guide plate to form a cavity structure, the light from the light source of the light guide plate is transmitted to the lampshade ring unit through the cavity structure, then transmitted to the external environment. Further, the partial surrounding structures of each lampshade ring unit of the linear lampshade are formed into an entirety, and form a fully surrounded linear cavity with the engagement of the light guide plate. Furthermore, in each of the embodiments, at least one of the first and second fixing portions has an elastic deformation structure. In one of the embodiments, one of the first and second fixing portions has an elastic deformation structure, or both of the first and second fixing portions have elastic deformation structures; so as to facilitate the elastic clamping of the light guide plate, such that the mounting of the lampshade ring units is more firm. Furthermore, in each of the embodiments, the first and second fixing portion includes a set of fixing blocks, respectively, the set of fixing blocks includes two fixing blocks with a gap therebetween. With this design with the gap, when the two notch grooves of the lampshade ring unit respectively receive the opposite two extending end portions of the light guide plate, the first The fixing portion and the second fixing portion have a avoidance gap to avoid breakage when deformation occurs, which is advantageous for improving the working life of the first fixing portion and the second fixing portion. Furthermore, the two notch grooves of the two end portions of each of the lampshade ring units are opposite; in this way, the light guide plate is regular and symmetric, which is easier to be produced. Moreover, in each of the embodiments, a width of the notch groove is equal to or greater than a thickness of the extending end portion of the light guide plate; which is advantageous to place the light guide plate. In one of the embodiments, the two end portions of the lampshade ring unit with a C-shaped cross section defines a notch groove that is slightly wider than the thickness of the extending end portion of the light guide plate, such that the mold can be easily formed, and the inner distance of the two notch grooves is slightly less than the external thickness of the extending end portion of the light guide plate, such that two end portions of the lampshade ring unit can be opened via the plastic elasticity, and the light guide body can be inserted, in this case, the light guide body can be slightly fastened to combine with the lampshade ring unit, such that the threaded holes on the linear lampshade can be omitted, and the design can be more complete, the process can be simpler, and lampshade ring units with different plastic materials and colors can be used to perform the multicolor change of the linear lampshade. Moreover, in each of the embodiments, the lampshade ring unit has a rectangular shape projected on a plane perpendicular to a plane of symmetry of the two notch grooves. In one of the embodiments, the two end portions are symmetric. In one of the embodiments, the two end portions are symmetric with respect to a certain plane. In one of the embodiments, the whole lampshade ring unit is symmetric; in one of the embodiments, the whole lampshade ring unit is symmetric with respect to a certain plane. In this way, each lampshade ring units are arranged into a linear lampshade, in this case, each lampshade ring units of the linear lampshade are arranged side by side according to the same position, and each of the lampshade ring units spatially forms a translational coincidence structure, i.e., each of the lampshade ring units can spatially coincides with any one of lampshade ring units with a translation at a certain distance. Otherwise, in each of the embodiments, one end portion of the two end portions is a thin end portion, and another is a thick end portion, the lampshade ring unit has a isosceles trapezoid shape projected on a plane perpendicular to a plane of symmetry of the two notch grooves, and the upper bottom and the lower bottom of the isosceles trapezoid have extending ends, the width of the extending ends are limited by the range of the extending lines of the both sides of the isosceles trapezoid. It should be understood that, the width of the extending ends are limited by the range of the extending lines of the both sides of the isosceles trapezoid, which means that, assuming that extending lines of the two sides of the isosceles trapezoid are made in both directions, the extending ends are both entirely located in the area between the two sides and the extending lines thereof. In any two adjacent lampshade ring units, the thin end portion of the first lampshade ring unit is adjacent to the thick end portion of the second lampshade ring unit, and the thick end portion of the first lampshade ring unit is adjacent to the thin end portion of the second lampshade ring unit; i.e., a thin end portion is forward mounted, and the other thin end portion adjacent thereto is reversely mounted, so that the thin and thick end portions are offset, and the linear lampshades formed by the plurality of lampshade ring units are arranged in a straight line. With this design, when a plurality of lampshade ring units are regularly arranged and adjacent to each other, it is advantageous to prevent the adjacent lampshade ring units from forming a concave or convex shape, affecting the shape of the linear lampshade, and causing a mismatch between the shape of the lampshade and the light guide plate.

In one of the embodiments, the light source includes a PCB and at least one LED that located on the PCB, and a control structure thereof; the light-transmitting body is provided with the elastic portion; the light-transmitting body and the two end portions are integrally provided, or the light-transmitting body and the two end portions forms an integrally provided acrylic structure. The partial surrounding structure can be C-shaped, U-shaped, CD-shaped, V-shaped, linear, curved, or of a combined shape thereof. At least one of the first and second fixing portions has an elastic deformation structure, the first and second fixing portion includes a set of fixing blocks, respectively, and the set of fixing blocks includes two fixing blocks with a gap therebetween. The two notch grooves of the two end portions of each of the lampshade ring units are symmetrical, the width of the notch groove is equal to or greater than the thickness of the light guide body, and the lampshade ring unit has a rectangular shape projected on a plane perpendicular to a plane of symmetry of the two notch grooves. Otherwise, one end portion of the two end portions is a thin end portion, and another is a thick end portion, the lampshade ring unit has a isosceles trapezoid shape projected on a plane perpendicular to a plane of symmetry of the two notch grooves, and the upper bottom and the lower bottom of the isosceles trapezoid have extending ends, the width of the extending ends are limited by the range of the extending lines of the both sides of the isosceles trapezoid. In any two adjacent lampshade ring units, the thin end portion of the first lampshade ring unit is adjacent to the thick end portion of the second lampshade ring unit, and the thick end portion of the first lampshade ring unit is adjacent to the thin end portion of the second lampshade ring unit.

In one of the embodiments of the lampshade ring units, the light-transmitting body is provided with the elastic portion; the light-transmitting body and the two end portions are integrally provided, or the light-transmitting body and the two end portions forms an integrally provided acrylic structure. The partial surrounding structure can be C-shaped, U-shaped, GC-shaped, V-shaped, linear, curved, or of a combined shape thereof. At least one of the first and second fixing portions has an elastic deformation structure. The first and second fixing portion includes a set of fixing blocks, respectively, the set of fixing blocks includes two fixing blocks with a gap therebetween. The lampshade ring unit has a rectangular shape projected on a plane perpendicular to a plane of symmetry of the two notch grooves. Otherwise, one end portion of the two end portions is a thin end portion, and another is a thick end portion, the lampshade ring unit has a isosceles trapezoid shape projected on a plane perpendicular to a plane of symmetry of the two notch grooves, and the upper bottom and the lower bottom of the isosceles trapezoid have extending ends, the width of the extending ends are limited by the range of the extending lines of the both sides of the isosceles trapezoid.

In one of the embodiments, the rail structure or the rail lighting structure further includes a conductive switch. In one of the embodiments, the conductive switch includes a connecting end, the connecting end includes a first connecting end and a second connecting end, the first connecting end is connected to the first connecting body, and the second connecting end is connected to the second connecting body. In one of the embodiments, the conductive switch has a casing and a switching portion located in the casing, the connecting end is provided with an elastic portion and a connecting portion, an end of the connecting portion is exposed outside the casing, the elastic portion is at least partially located between another end of the connecting portion and the switching portion, one end of the connecting portion abuts against the connecting body and applies a force to the elastic portion, such that the elastic portion is deformed and the another end of the connecting portion abuts the switching portion. In one of the embodiments, the switching portion further comprises a manual switch knob or a wireless receiving module configured for determining the conduction of the conductive switch. In one of the embodiments, the conductive switch is fully located in the body, or the conductive switch is slidably located in the body, and is partially located outside the body.

In one of the embodiments, the rail structure or the rail lighting structure further includes a lighting device slidably located in the body and partially located outside the body. In one of the embodiments, the lighting device is a spotlight, a light strip, a light holder, or the like. In this way, richer ways of lighting can be achieved.

In one of the preferred embodiments, the rail further has a first mounting area and a second mounting area formed by the body, respectively. At least two first protruding portions are extended from the body at the first mounting area, and at least two second protruding portions are extended from the body at the second mounting area. The first connecting body is located at the first mounting area and abuts against the at least two first protruding portions, and the second connecting body is located at the second mounting area and abuts against the at least two second protruding portions. The first mounting area and the second mounting area are in communication with the light outgoing area, respectively. The first connecting body comprises a first insulating abutting portion and a first conductor, the first insulating abutting portion defines a first mounting groove, and an extending direction of the first mounting area is the same as the extending direction of the rail, the first insulating abutting portion is located at the first mounting area and abuts against the at least two first protruding portions, the first conductor is located in the first mounting groove and is partially exposed outside the first mounting groove, and an extending direction of the exposed portion of the first conductor is the same as the extending direction of the rail. The second connecting body comprises a second insulating abutting portion and a second conductor, the second insulating abutting portion defines a second mounting groove, and an extending direction of the second mounting area is the same as the extending direction of the rail, the second insulating abutting portion is located at the second mounting area and abuts against the at least two second protruding portions, the second conductor is located in the second mounting groove and is partially exposed outside the second mounting groove, and an extending direction of the exposed portion of the second conductor is the same as the extending direction of the rail. And the first insulating abutting portion buts against the body and defines at least two gap areas with the body at the first mounting area, and the second insulating abutting portion buts against the body and defines at least two gap areas with the body at the second mounting area.

In one of the preferred embodiments, the rail includes a body and a light outgoing area formed by the body. The body further defines an opening position in communication with the light outgoing area, and the opening position is located at a light emitting direction of the light outgoing area. The body has an extending end located at the opening position, and the extending end is configured to fix a light guide plate; and the body defines a light source mounting position, the light source mounting position is adjacent to the light outgoing area, and is configured to mount a light source and ensure that the light emitting direction of the light source faces the light outgoing area and opening position. The rail further includes a connecting body, the connecting body includes a first connecting body and a second connecting body, the first connecting body and the second connecting body are both located on the body and are electrically coupled to an anode circuit and a cathode circuit, respectively. The first connecting body and the second connecting body are both inserted on the body, the rail further has a first mounting area and a second mounting area formed by the body, respectively. At least two first protruding portions are extended from the body at the first mounting area, and at least two second protruding portions are extended from the body at the second mounting area. The first connecting body is located at the first mounting area and abuts against the at least two first protruding portions, and the second connecting body is located at the second mounting area and abuts against the at least two second protruding portions; the first mounting area and the second mounting area are in communication with the light outgoing area, respectively. The first connecting body comprises a first insulating abutting portion and a first conductor, the first insulating abutting portion defines a first mounting groove, and an extending direction of the first mounting area is the same as the extending direction of the rail, the first insulating abutting portion is located at the first mounting area and abuts against the at least two first protruding portions, the first conductor is located in the first mounting groove and is partially exposed outside the first mounting groove, and an extending direction of the exposed portion of the first conductor is the same as the extending direction of the rail. The second connecting body comprises a second insulating abutting portion and a second conductor, the second insulating abutting portion defines a second mounting groove, and an extending direction of the second mounting area is the same as the extending direction of the rail, the second insulating abutting portion is located at the second mounting area and abuts against the at least two second protruding portions, the second conductor is located in the second mounting groove and is partially exposed outside the second mounting groove, and an extending direction of the exposed portion of the second conductor is the same as the extending direction of the rail. The first insulating abutting portion buts against the body and defines at least two gap areas with the body at the first mounting area, and the second insulating abutting portion buts against the body and defines at least two gap areas with the body at the second mounting area. According to the aforementioned rail, by the design of the connecting body and the structure thereof, the connection of the rail can be achieved by placing the first and the second conductive body onto the corresponding positions of the rail, and the light source mounting position facilitates the mounting of the light source. In application, the first and the second connecting body can be separately produced and mounted, the abutting portion and the conductive body in the connecting body can also be separately produced and mounted; the lengths of the rail and the connecting body thereof can be standard or longer, as long as they can engage with the light source.

In one of the preferred embodiments, the rail structure includes a rail according to any one of the embodiments, a conductive input connector according to any one of the embodiments, and a lampshade ring unit according to any one of the embodiments. In one of the preferred embodiments, the rail structure includes a rail according to any one of the embodiments, a conductive input connector according to any one of the embodiments, and a light guide plate according to any of the embodiments. Accordingly, in one of the preferred embodiments, the rail structure includes a rail, a conductive input connector, and a light guide plate; the rail includes a body and a light outgoing area formed by the body; the body further defines an opening position in communication with the light outgoing area, and the opening position is located at a light emitting direction of the light outgoing area. The body has an extending end located at the opening position, and the extending end is configured to fix a light guide plate; and the body defines a light source mounting position, the light source mounting position is adjacent to the light outgoing area, and is configured to mount a light source. The rail further includes a connecting body; the connecting body includes a first connecting body and a second connecting body, the first connecting body and the second connecting body are both located on the body and are coupled to an anode circuit and a cathode circuit, respectively. The first connecting body and the second connecting body are both inserted on the body. The rail further has a first mounting area and a second mounting area formed by the body, respectively. At least two first protruding portions are extended from the body at the first mounting area, and at least two second protruding portions are extended from the body at the second mounting area. The first connecting body is located at the first mounting area and abuts against the at least two first protruding portions, and the second connecting body is located at the second mounting area and abuts against the at least two second protruding portions; the first mounting area and the second mounting area are in communication with the light outgoing area, respectively. The first protruding portion and the second protruding portion are both elongated, and extending directions of the first protruding portion and the second protruding portion are the same as an extending direction of the rail. The first connecting body includes a first insulating abutting portion and a first conductor, the first insulating abutting portion defines a first mounting groove, and an extending direction of the first mounting area is the same as the extending direction of the rail, the first insulating abutting portion is located at the first mounting area and abuts against the at least two first protruding portions, the first conductor is located in the first mounting groove and is partially exposed outside the first mounting groove, and an extending direction of the exposed portion of the first conductor is the same as the extending direction of the rail. The second connecting body includes a second insulating abutting portion and a second conductor, the second insulating abutting portion defines a second mounting groove, and an extending direction of the second mounting area is the same as the extending direction of the rail, the second insulating abutting portion is located at the second mounting area and abuts against the at least two second protruding portions, the second conductor is located in the second mounting groove and is partially exposed outside the second mounting groove, and an extending direction of the exposed portion of the second conductor is the same as the extending direction of the rail. Two rail mounting portions are extending outwardly from the rail, and each of the rail mounting portions defines a groove area with other portions of the body. The rail mounting portion is provided with a first protrusion and a second protrusion, and a recessed area is defined between the first protrusion and the second protrusion. The conductive input connector is partially inserted into the body, and includes a connecting portion, the connecting portion includes a first connecting portion and a second connecting portion, the first connecting portion abuts against the first connecting body, and the second connecting portion abuts against the second connecting body; the light guide plate is provided on the body via the two sliding grooves and covers the opening position. The light guide plate includes a light guide body and two sliding grooves defined on the light guide body, and the light guide plate is provided on the body via the two sliding grooves and covers the opening position. The light guide body has a light outgoing flat surface, a light outgoing curved surface, or a light composite surface. The light composite surface is formed by at least two light outgoing flat surfaces, formed by at least two light outgoing curved surfaces, or formed by at least one light exiting and at least one light outgoing curved surface. Extending end portions are extended outwardly from a side of the light guide body away from the rail, respectively. The other preferred embodiments are analogous.

In one of the preferred embodiments, the rail lighting structure includes a conductive input connector, a connecting body, a conductive switch, a rail, a light source, and a light guide plate; the rail includes a body and a light outgoing area formed by the body. The body further defines an opening position in communication with the light outgoing area, and the opening position is located at a light emitting direction of the light outgoing area, the light guide plate is located in the body and covers the opening position; the connecting body includes a first connecting body and a second connecting body, the first connecting body and the second connecting body are both located on the body and are coupled to an anode circuit and a cathode circuit, respectively. The rail further has a first mounting area and a second mounting area formed by the body, respectively. At least two first protruding portions are extended from the body at the first mounting area, and at least two second protruding portions are extended from the body at the second mounting area. The first connecting body is located at the first mounting area and abuts against the at least two first protruding portions, and the second connecting body is located at the second mounting area and abuts against the at least two second protruding portions; the first mounting area and the second mounting area are in communication with the light outgoing area, respectively. The first connecting body includes a first insulating abutting portion and a first conductor, the first insulating abutting portion defines a first mounting groove, and an extending direction of the first mounting area is the same as the extending direction of the rail, the first insulating abutting portion is located at the first mounting area and abuts against the at least two first protruding portions, the first conductor is located in the first mounting groove and is partially exposed outside the first mounting groove, and an extending direction of the exposed portion of the first conductor is the same as the extending direction of the rail. The second connecting body includes a second insulating abutting portion and a second conductor, the second insulating abutting portion defines a second mounting groove, and an extending direction of the second mounting area is the same as the extending direction of the rail, the second insulating abutting portion is located at the second mounting area and abuts against the at least two second protruding portions, the second conductor is located in the second mounting groove and is partially exposed outside the second mounting groove, and an extending direction of the exposed portion of the second conductor is the same as the extending direction of the rail. The first insulating abutting portion buts against the body and defines at least two gap areas with the body at the first mounting area, and the second insulating abutting portion buts against the body and defines at least two gap areas with the body at the second mounting area; the conductive input connector is partially inserted into the body, and comprises a connecting portion, the connecting portion comprises a first connecting portion and a second connecting portion, the first connecting portion abuts against the first connecting body, and the second connecting portion abuts against the second connecting body. The conductive switch includes a connecting end, the connecting end comprises a first connecting end and a second connecting end, the first connecting end is connected to the first connecting body, and the second connecting end is connected to the second connecting body.

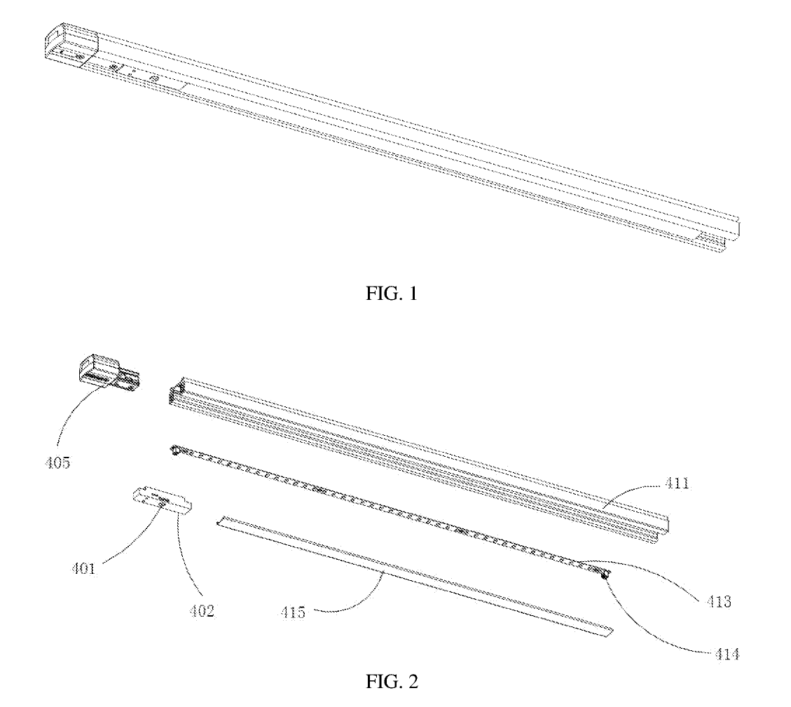

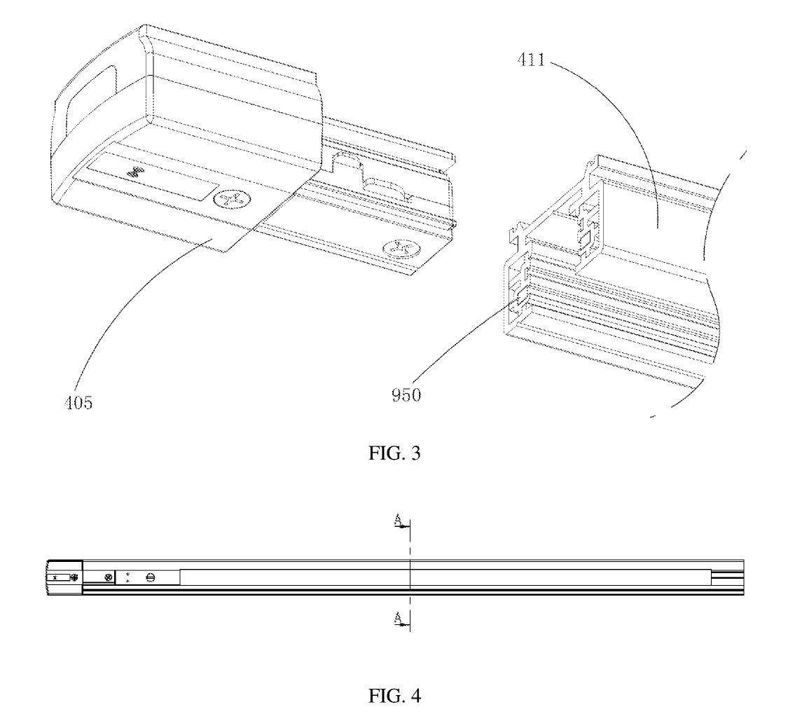

In one of the embodiments, a rail lighting structure is shown in FIG. 1, also referring to FIG. 2 and FIG. 3, the rail lighting structure includes a conductive input connector 405, a connecting body 950 (inside a rail 411 in FIG. 2), a conductive switch 402 (also referred as a conductive switch connector), the rail 411, a light source 413, and a light guide plate 415. The light guide plate 415 is snapped into the opening position of the rail 411, and this kind of the light guide plate can also be referred as a snap-in light guide plate. The light source 413 is connected to the body of the rail 411 by screwing or gluing, and the light source 413 emits light towards the light outgoing area and the opening position. The light source 413 is provided with a quick-plug terminal 414 and a plurality of LED lights. The conductive switch 402 has a switch knob 401 configured to control the on/off state of the conductive switch 402.

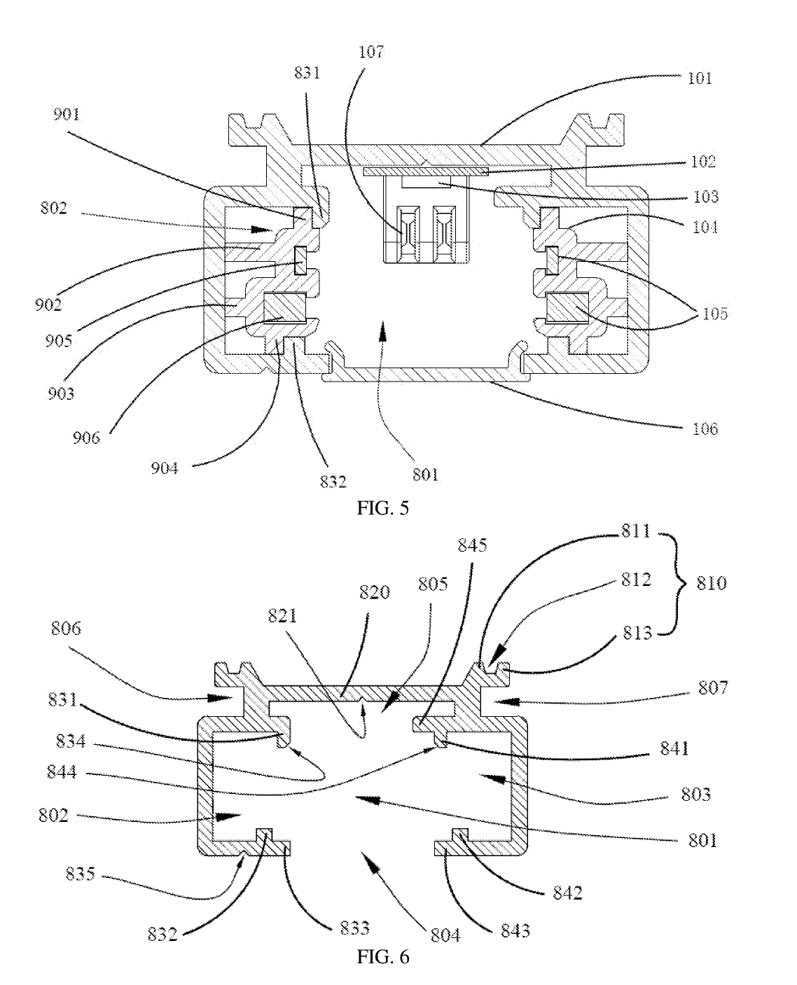

Referring to FIG. 4, FIG. 5, and FIG. 6, the rail has the body 101 and the light outgoing area 801 formed by the body 101. The light source is a LED strip 102, and the LED strip 102 has LED chips 103. A conductive copper strip 105 is a conductive body of the connecting body, the conductive copper strip 105 is mounted in the body via a rail insulating strip 104. The snap-in light guide plate 106 is located on the body and covers the opening position at the light emitting direction of the light outgoing area. The body 101 defines the light outgoing area 801, a first mounting are 802, a second mounting area 803, the opening position 804, a light source mounting area 805, a first groove area 806, and a second groove area 807. Additionally, the body 101 further defines an auxiliary positioning port 835 for limiting the displacement of the rail during production, transportation, or other using environment. The body 101 further defines a light source positioning port 821 for limiting the position of the light source when the light source is mounted to the light source mounting area 805. The body 101 further defines a first inclined surface 834 at a first primary protruding portion 831 for mounting the first connecting body, and the body 101 further defines a second inclined surface 844 at a second primary protruding portion 841 for mounting the second connecting body. The first inclined surface 834 and the second inclined surface 844 are opposite to each other. Additionally, the body 101 further has a third extending section 845 for controlling the position of the LED strip 102. The first mounting area 802 and the second mounting area 803 are formed by the body, respectively. Two first protruding portions are extending from the body 101 at the first mounting area 802. The first protruding portions include the first primary protruding portion 831 and a first secondary protruding portion 832. Two second protruding portions are extended from the body at the second mounting area 803, the second protruding portions include the second primary protruding portion 841 and a second secondary protruding portion 842. The first primary protruding portion 831 and the first secondary protruding portion 832 are used to cooperate with the body 101 to limit the position of the first connecting body at the first mounting area 802. The second primary protruding portion 841 and the second secondary protruding portion 842 are used to cooperate with the body 101 to limit the position of the second connecting body at the second mounting area 803, so as to avoid unexpected movements of the first connecting body and the second connecting body relative to the body except the extending direction of the body. The light source is mounted in the light source mounting position 820 via the light source mounting area 805, and the light from the light source emits from the opening position 804 through the light guide plate via the light outgoing area 801. The body 101 further has a first extending section 833 and a second extending section 843 at the two sides of the opening position 804. The snap-in light guide plate 106 is located at the first extending section 833 and the second extending section 843, and covers the opening position 804. The body 101 further has a rail mounting portion 810, the rail mounting portion 810 includes a first protrusion 811 and a second protrusion 813. A recessed area 812 is defined between the first protrusion 811 and the second protrusion 813. The first protrusion 811, the recessed area 812, and the second protrusion 813 cooperatively engage to improve the overall strength and mounting convenience of the rail mounting portion 810. The first groove area 806 and the second groove area 807 are used to engage with the two rail mounting portions 810 to cooperatively mount the rail or the body.

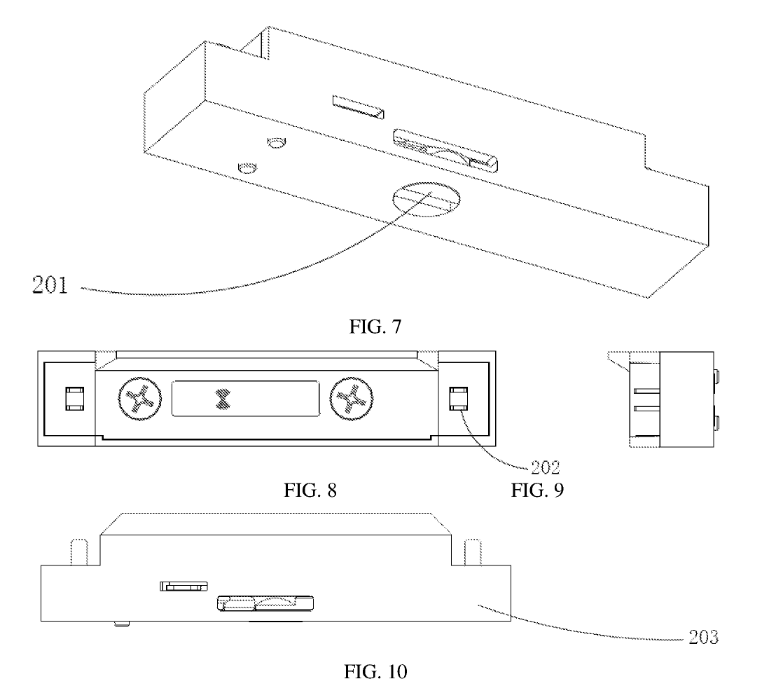

Referring to FIG. 5 and FIG. 6, the first connecting body includes a first insulating abutting portion and a first conductor. The first insulating abutting portion defines two first mounting grooves correspondingly. The number of the first conductors is two. The first conductor includes a first primary conductor 905 and a first secondary conductor 906, and the first primary conductor 905 and the first secondary conductor 906 are both copper strips. Similarly, the conductive copper strip 105 also includes two second conductors, i.e., two conductive copper strips are provided. The first insulating abutting portion defines a first abutting position 901, a second abutting position 902, a third abutting position 903, and a fourth abutting position 904. The first abutting position 901, the second abutting position 902, the third abutting position 903, and the fourth abutting position 904 abut against the body 101 in the first mounting area 802, respectively, such that the first insulating abutting portion and one of the first conductors are limited in the first mounting area 802 and can only move along the extending direction of the body 101. A conductive switch is shown in FIG. 7 to FIG. 10, the conductive switch 203 has a switch knob 201 and a quick-plug male terminal 202. Another conductive switch is shown in FIG. 11 to FIG. 14, the conductive switch 303 has a built-in Bluetooth module, which can also be referred as conductive Bluetooth device switch or conductive Bluetooth device switch connector, and has a switch setting knob 301 and a quick-plug male terminal 302, so as to receive the Bluetooth signal to control on/off of the circuit.

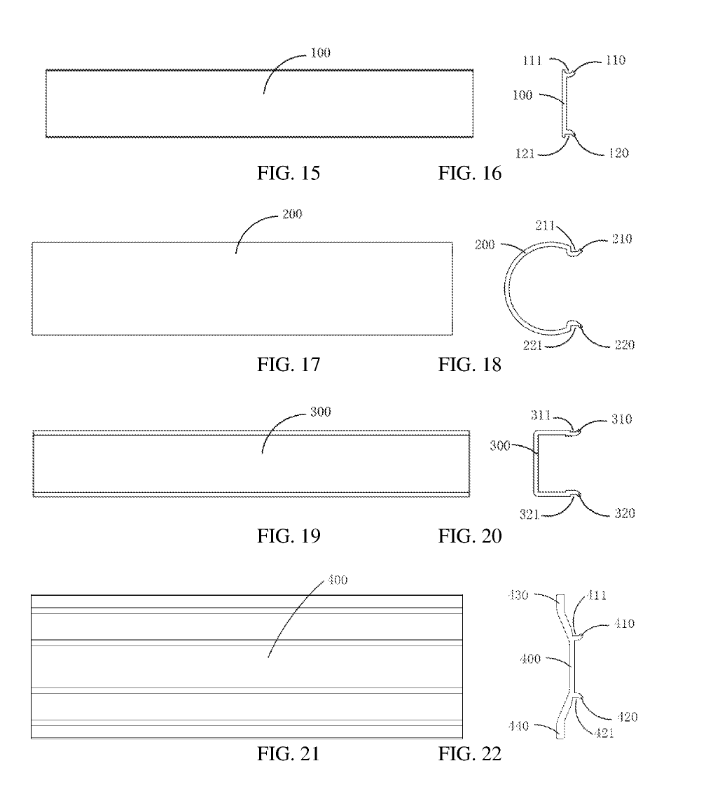

A light guide plate is shown in FIG. 15 and FIG. 16, it has a planar light guide surface 100, a first snapping portion 110 and a second snapping portion 120. A first sliding groove 111 is defined between the first snapping portion 110 and the planar light guide surface 100, and a second sliding groove 121 is defined between the second snapping portion 120 and the planar light guide surface 100. The light guide plate is mounted on the body and covers the opening position via the first snapping portion 110 and the first sliding groove 111 thereof, the second snapping portion 120 and the second sliding groove 121 thereof, the first extending section 833, and the second extending section 843.

A light guide plate according to one embodiment is shown in FIG. 17 and FIG. 18, it has a curved surface light guide surface 200, a first snapping portion 210 and a second snapping portion 220. A first sliding groove 211 is defined between the first snapping portion 210 and the curved surface light guide surface 200, and a second sliding groove 221 is defined between the second snapping portion 220 and the curved surface light guide surface 200. The light guide plate is mounted on the body and covers the opening position via the first snapping portion 210 and the first sliding groove 211 thereof, the second snapping portion 220 and the second sliding groove 221 thereof, the first extending section 833, and the second extending section 843.

A light guide plate according to another embodiment is shown in FIG. 19 and FIG. 20, it has a rectangular light guide surface 300, a first snapping portion 310, and a second snapping portion 320. a first sliding groove 311 is defined between the first snapping portion 310 and the rectangular light guide surface 300, and a second sliding groove 321 is defined between the second snapping portion 320 and the rectangular light guide surface 300. The light guide plate is mounted on the body and covers the opening position via the first snapping portion 310 and the first sliding groove 311 thereof, the second snapping portion 320 and the second sliding groove 321 thereof, the first extending section 833, and the second extending section 843.

A light guide plate according to yet another embodiment is shown in FIG. 21 and FIG. 22, it has an add-on light guide surface 400, a first snapping portion 410 and a second snapping portion 420. A first sliding groove 411 is defined between the first snapping portion 410 and the add-on light guide surface 400, and a second sliding groove 421 is defined between the second snapping portion 420 and the add-on light guide surface 400. The light guide plate is mounted on the body and covers the opening position via the first snapping portion 410 and the first sliding groove 411 thereof, the second snapping portion 420 and the second sliding groove 421 thereof, the first extending section 833, and the second extending section 843.

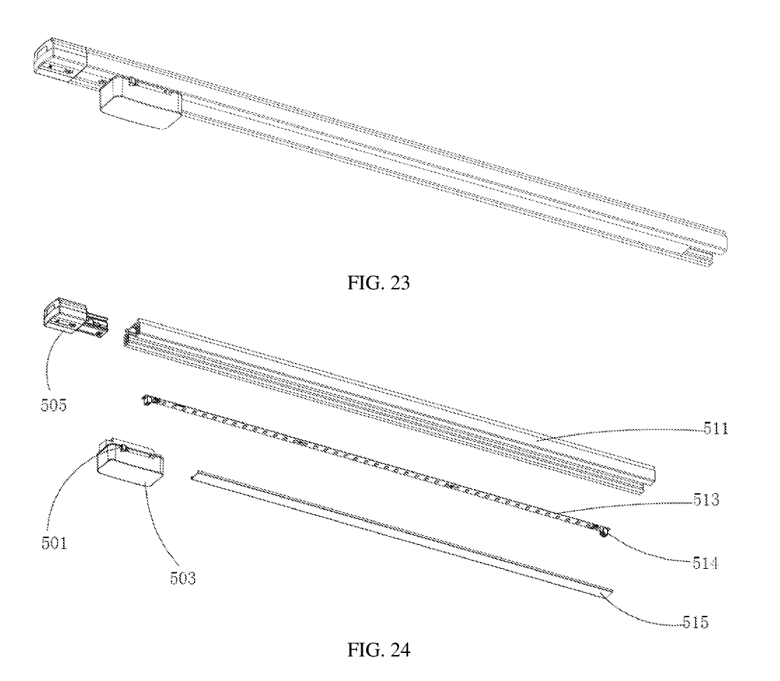

In one of the embodiments, a rail lighting structure is shown in FIG. 23. Also referring to FIG. 24, the rail lighting structure includes a conductive input connector 505, a connecting body (inside a rail 511), a Bluetooth conductive switch 503 (also referred as conductive Bluetooth device switch or conductive Bluetooth device switch connector), the rail 511, a light source 513, and a light guide plate 515. The light source 513 includes a quick-plug terminal 514 and a plurality of LED chips. The conductive switch 503 has a switch setting knob 501 used to control the on/off state of the conductive switch. The Bluetooth conductive switch is the aforementioned built-in Bluetooth module of the conductive switch, which is configured to receive the Bluetooth signal to control on/off if the circuit.

Further, the rail lighting structure further includes a lampshade arranged on the light guide panel, and the light guide plate is located between the lampshade and the light source. In one of the embodiments, the lampshade is fixed on the light guide panel. In one of the embodiments, the lampshade is hung on the light guide plate. Additionally, the light guide plate has an add-on light guide surface, the rail light structure further includes a lampshade arranged on the add-on light guide surface, and the light guide plate is located between the lampshade and the light source.

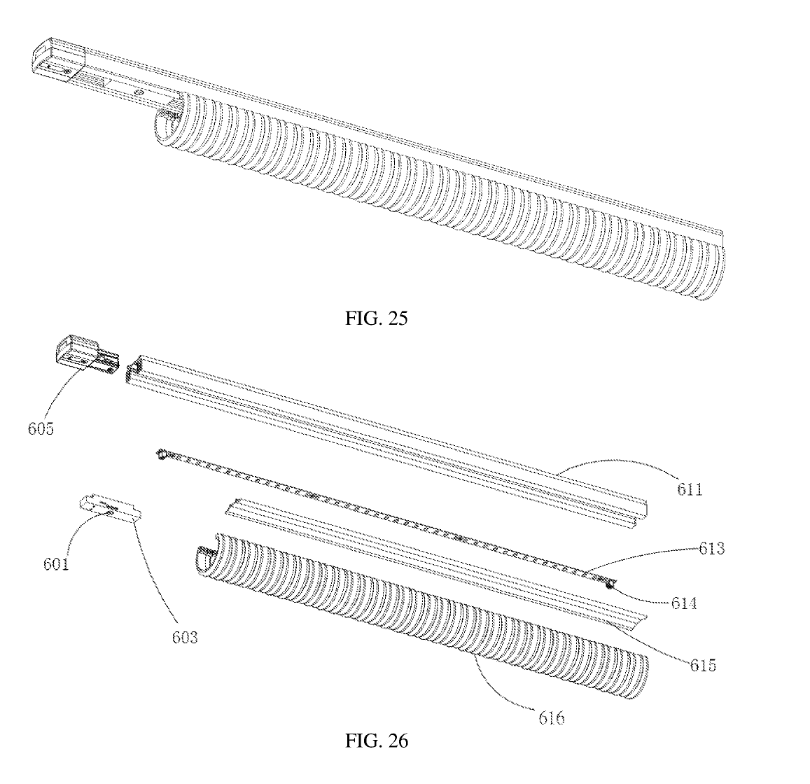

Another rail lighting structure is shown in FIG. 25 to FIG. 28. The rail lighting structure includes a conductive input connector 605, a connecting body (inside a rail 611), a conductive switch 603, the rail 611, a light source 613, a light guide plate 615, and a lampshade 616. The light source 613 is provided with a quick-plug terminal 614 and a plurality of LED lights. The conductive switch 603 has a switch knob 601 configured to control the on/off state of the conductive switch. The light guide plate 615 has an add-on light guide surface, the lampshade 616 is hung on the light guide plate 615, and the lampshade 616 includes a plurality of regularly arranged lampshade unit rings.

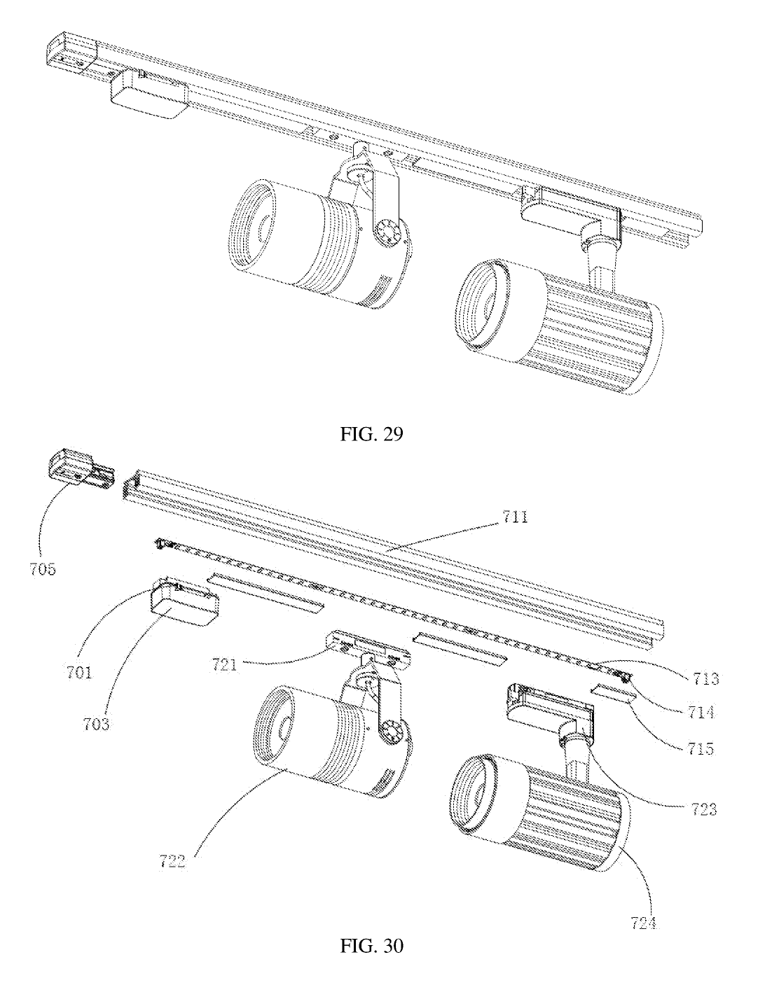

Another rail lighting structure is shown in FIG. 29 to FIG. 30, the rail lighting structure includes a conductive input connector 705, a connecting body (inside a rail 711), a Bluetooth conductive switch 703 (also referred as conductive Bluetooth device switch or conductive Bluetooth device switch connector), the rail 711, a light source 713, a light guide plate 715, a spotlight connector, and a spotlight. The light source 713 includes a quick-plug terminal 714 and a plurality of LED lights. The conductive switch 703 has a switch setting knob 701 configured to control the on/off state of the conductive switch. The Bluetooth conductive switch is the aforementioned built-in Bluetooth module of the conductive switch, which is used to receive the Bluetooth signal to control on/off if the circuit. The spotlight connector is located on the rail 711, and the spotlight is mounted on the spotlight connector. In one of the embodiments, the spotlight connector includes a buried connector and/or an add-on connector. As shown in FIG. 30, the rail lighting structure includes a buried connector 721, a first spotlight 722 mounted on the buried connector 721, an add-on connector 723, and a second spotlight 724 mounted on the add-on connector 723.

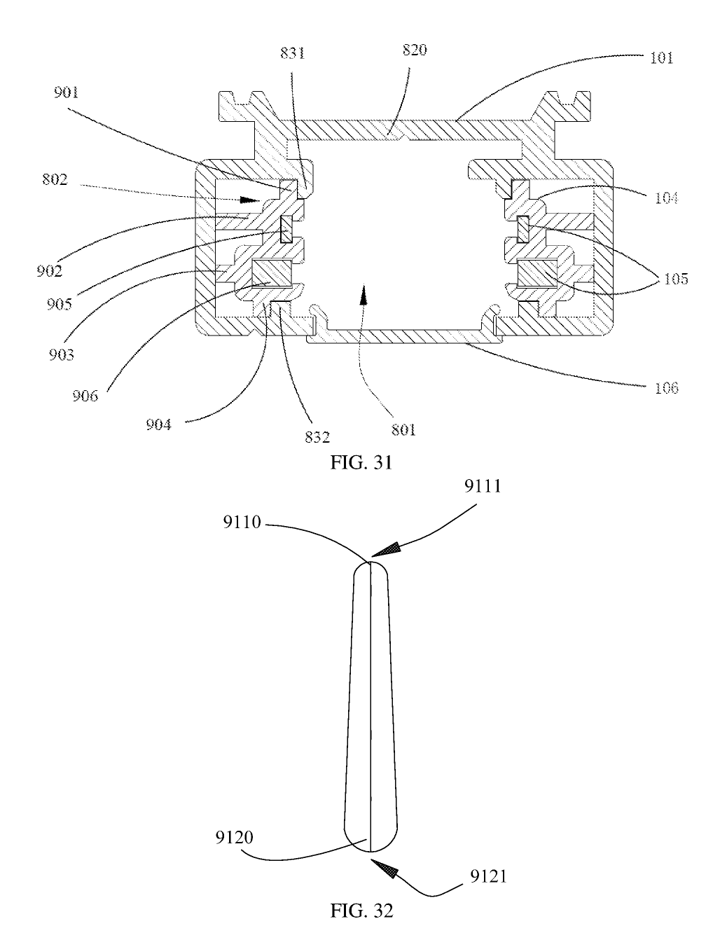

It should be understood that, the embodiment shown in FIG. 1 to FIG. 30 can be considered as embodiments of rail structures when no light sources are included. Another rail structure is shown in FIG. 31, which includes a rail, a light guide plate, and a connecting body. Referring to FIG. 1, FIG. 3, and FIG. 4, the connecting body is located in the rail 411, the light guide plate 106 is located on the body 101 and covers the opening position 801. The conductive copper strip 105 serves as the second conductive body of the connecting body such as the second connecting body. The rail insulating strip 104 serves as a second insulating abutting portion of the connecting body such as the second connecting body. The conductive copper strip 105 is mounted in the body via the rail insulating strip 104. Referring to FIG. 6, the snap-in light guide plate 106 is located in the body 101, and is located in the light emitting direction of the light outgoing area 801 and covers the opening position 804. The rail has the body 101 and the light outgoing area 801 formed by the body 101, the first mounting are 802, the second mounting area 803, and the first mounting are 802 and the second mounting area 803 are in communication with the light outgoing area 801, respectively. The body 101 further has the light source mounting position 820 configured to mount the light source, and to direct the light emitting direction of the light source toward the light outgoing area 801 and the opening position 804, i.e., toward the snap-in light guide plate 106.

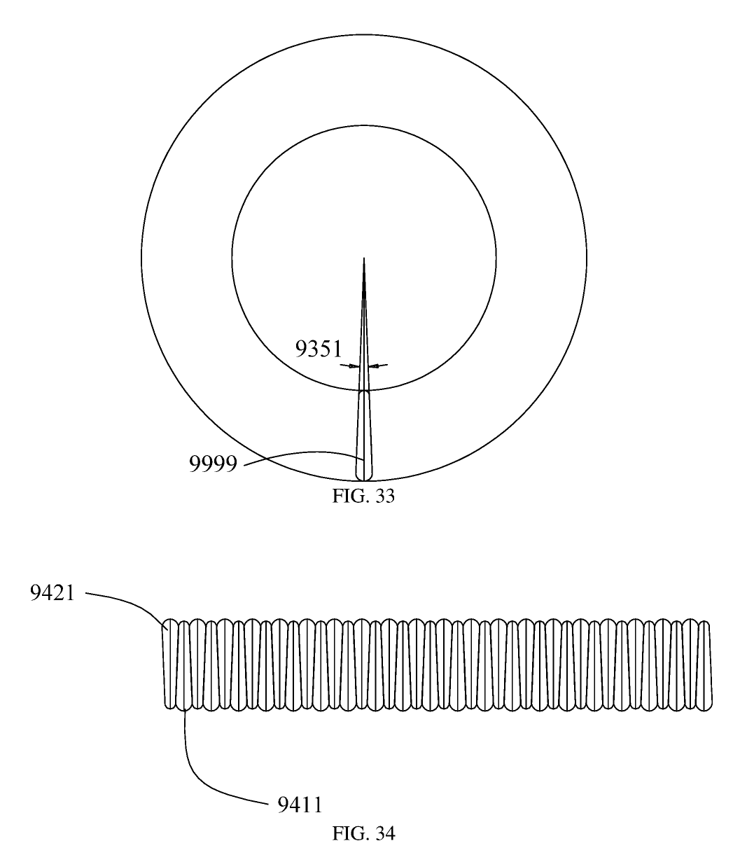

Referring to FIG. 32 and FIG. 33, it can be seen that, as the taper 9351 of the lampshade ring unit 9999 is different, the widths of the thin end portion 9110 and the thick end portion 9120 also change, thereby forming various arrangement effects. In one of the embodiments, the taper 9351 of the lampshade ring unit 9999 is slightly less than 4.5 degree, and in one of the embodiments, the taper 9351 is 4.4 degree. Therefore, a decentralized scheme is generally achieved, a plurality of lampshade ring units cooperatively form a linear lampshade, the thin end portion and the thick end portion of each adjacent lampshade ring units match to each other, so as to achieve the effect that the individual lampshade ring units are completely abutted together without too much leakage, and become a whole linear lampshade in appearance. A linear lampshade formed by matching the thin end portions and thick end portions of a plurality of the lampshade ring units is shown in FIG. 34.

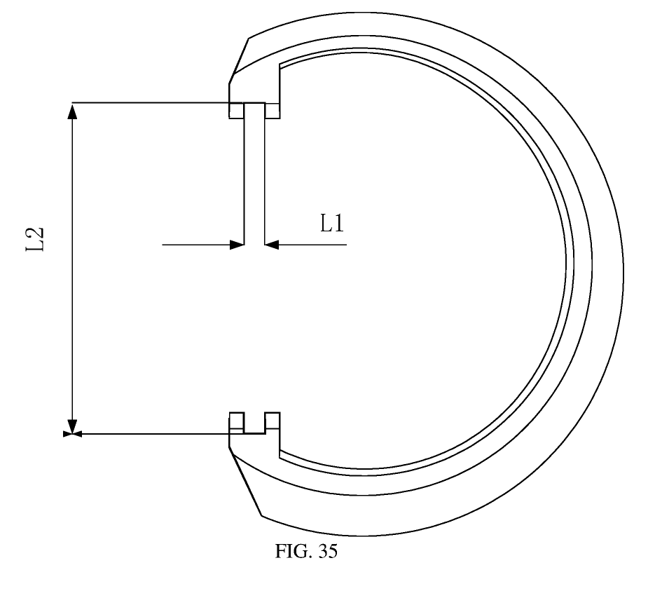

In one of the embodiment, as shown in FIG. 35, for each of the lampshade ring units, a width L1 of the notch groove of the fixing structure of the end portion is slightly greater than the thickness of the mounting position of the body or the extended end portion of the light guide body, and the notch groove is configured to receive the mounting position of the body or the extended end portion of the light guide body. Being slightly greater means being greater in a slight extent. In one of the embodiment, the width L1 of the notch groove is slightly greater than the thickness of the mounting position of the body or the extended end portion of the light guide body. Specifically, the width L1 of the notch groove is from 1.05 to 10 times to the thickness of the mounting position of the body or the extended end portion of the light guide body. In one of the embodiments, the width L1 of the notch groove is from 1.1 to 2 times to the thickness of the mounting position of the body or the extended end portion of the light guide body. If the width L1 is too small, the lampshade ring units are difficult to mount, and if the width L1 is too large, the lampshade ring units may loosen. Further, an opening width L2 of the partial surrounding structure of the lampshade ring unit, i.e. the distance L2 between the fixing structures of the two end portions, is slightly less than a width of the mounting position of the body or the two extended end portions of the light guide body, and it is used for the lampshade ring unit to snap in.

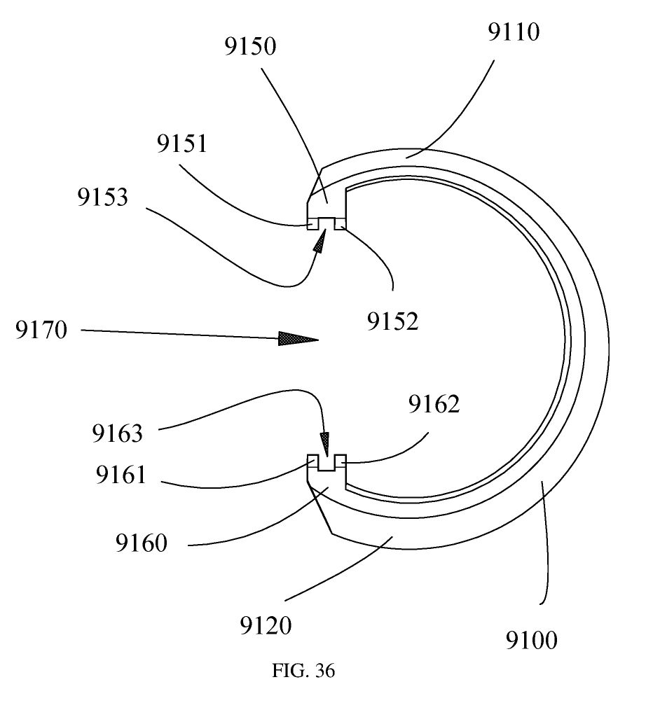

For each of the lampshade ring units, in one of the embodiments, as shown in FIG. 36, the lampshade ring unit includes a light-transmitting body 9100 and two end portions connected to the light-transmitting body. The two end portions includes a first end portion 9110 and a second end portion 9120, and the first end portion 9110, the second end portion 9120, and the light-transmitting body 9100 cooperatively forms a partial surrounding structure. The partial surrounding structure is configured to form an open-ended opening area 9170, and the partial surrounding structure and the light guide body cooperatively form a full surrounding structure via the opening area 9170. Each of the end portions has a fixing structure, the first end portion 9110 has a primary fixing structure 9150, and the second end portion 9120 has a second primary fixing structure 9160. In each of the fixing structures, the fixing structure includes a first fixing portion and a second fixing portion, a notch groove is defined between the first and the second fixing portion. The primary fixing structure 9150 includes a primary first fixing portion 9151 and a primary second fixing portion 9152, and a first notch groove 9153 is defined between the first and the second fixing portion. The secondary fixing structure 9160 includes a secondary first fixing portion 9161 and a secondary second fixing portion 9162, and a second notch groove 9163 is defined between the first and the second fixing portion. The first notch groove 9153 and the second notch groove 9163 are configured to receive the two extending end portions of the light guide plate or the mounting positions of the body, respectively, such that the lampshade ring unit is relatively fixed at the two sides of the mounting position of the body or the light guide plate.

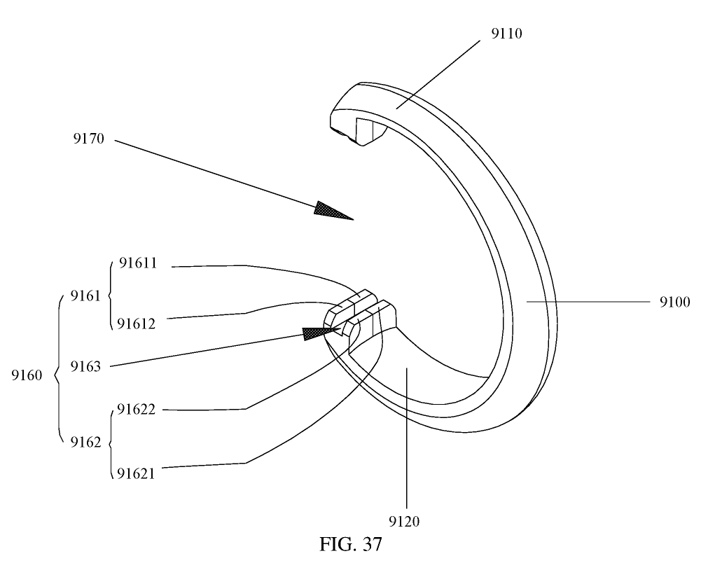

In one of the embodiments, as shown in FIG. 37, the secondary first fixing portion 9161 and the secondary second fixing portion 9162 include a set of fixing blocks, respectively. The set of fixing blocks includes two fixing blocks, the two fixing blocks of the secondary first fixing portion 9161 are secondary first fixing block A 91611 and the secondary first fixing block B 91612 with a gap therebetween. The two fixing blocks of the secondary second fixing portion 9162 are secondary second fixing block A 91621 and the secondary second fixing block B 91622 with a gap therebetween. This is advantageous to form a buffer to extend product life.

The mounting method is illustrated as examples hereinafter. In one of the embodiments, the light source is an LED thin light strip, quick-plug female terminals are welded to both ends of the LED light strip. The LED thin light strip is screwed onto an inner bottom of an opening of the rail via screws, or the LED strip is attached to the adhesive and is adhered to the inner bottom of the opening of the rail via a heat-conductive double-sided adhesive. The inner bottom of the opening of the rail means an inside of the body. In one of the embodiments, the inner bottom of the opening of the rail is the light source mounting position inside the body. The conductive switch has two male terminals that are inserted into the female terminals on the LED light strip. In one of the embodiments, a rotary joint switch is a switch knob. The light guide plate is snapped into the opening of the rail, such that the rail forms a rail with illumination. The shape of the light guide plate can be planer, round, square, external snapped plate, and so on. The conductive switch can be a snap switch or provided with a Bluetooth device. In one of the embodiments, Bluetooth controlling via mobile phone App can be realized. Therefore, the rail-light can be combined with the illuminating strip light, the rail spotlight and/or the Bluetooth controlling, which can be applied in occasions such as decoration project.

It should be understood that, other embodiments of the present disclosure further include rail structures, rail lighting structures, and rail structures including the rail lighting structures that can be implemented and formed by combining the technical features in the foregoing embodiments.

The technical features of the embodiments described above can be arbitrarily combined. In order to make the description succinct, there is no describing of all possible combinations of the various technical features in the foregoing embodiments. It should be noted that there is no contradiction in the combination of these technical features which should be considered as the scope of the description.

Although the present disclosure is illustrated and described herein with reference to specific embodiments, the present disclosure is not intended to be limited to the details shown. It is to be noted that, various modifications may be made in the details within the scope and range of equivalents of the claims and without departing from the present disclosure. Therefore, the protection scope of the present disclosure shall be subject to the protection scope of the claims.

What is claimed is:

1. A rail structure, comprising a rail;
wherein the rail comprises a body and a light outgoing area formed by the body;
the body further defines an opening position in communication with the light outgoing area, and the opening position is located at a light emitting direction of the light outgoing area;
the body has an extending end located at the opening position, and the extending end is configured to fix a light guide plate; and
the body defines a light source mounting position, the light source mounting position is adjacent to the light outgoing area and is configured to mount a light source.

2. The rail structure according to claim 1, wherein the rail further comprises a connecting body, the connecting body comprises a first connecting body and a second connecting body, the first connecting body and the second connecting body are both located on the body and are electrically coupled to an anode circuit and a cathode circuit, respectively.

3. The rail structure according to claim 2, wherein the first connecting body and the second connecting body are both inserted on the body.

4. The rail structure according to claim 3, wherein the rail further has a first mounting area and a second mounting area formed by the body, respectively; the body is provided with at least two first protruding portions at the first mounting area, and the body is provided with at least two second protruding portions at the second mounting area; the first connecting body is located at the first mounting area and abuts against the at least two first protruding portions, and the second connecting body is located at the second mounting area and abuts against the at least two second protruding portions; the first mounting area and the second mounting area are in communication with the light outgoing area, respectively.

5. The rail structure according to claim 4, wherein the first protruding portion and the second protruding portion are both elongated, and extending directions of the first protruding portion and the second protruding portion are the same as an extending direction of the rail.

6. The rail structure according to claim 4, wherein the first connecting body comprises a first insulating abutting portion and a first conductor, the first insulating abutting portion defines a first mounting groove, and an extending direction of the first mounting area is the same as the extending direction of the rail, the first insulating abutting portion is located at the first mounting area and abuts against the at least two first protruding portions, the first conductor is located in the first mounting groove and is partially exposed outside the first mounting groove, and an extending direction of the exposed portion of the first conductor is the same as the extending direction of the rail;
wherein the second connecting body comprises a second insulating abutting portion and a second conductor, the second insulating abutting portion defines a second mounting groove, and an extending direction of the second mounting area is the same as the extending direction of the rail, the second insulating abutting portion is located at the second mounting area and abuts against the at least two second protruding portions, the second conductor is located in the second mounting groove and is partially exposed outside the second mounting groove, and an extending direction of the exposed portion of the second conductor is the same as an extending direction of the rail.

7. The rail structure according to claim 1, further comprising a conductive input connector, wherein the conductive input connector is partially inserted into the body, and the conductive input connector comprises a connecting portion, the connecting portion comprises a first connecting portion and a second connecting portion, the first connecting portion abuts against the first connecting body, and the second connecting portion abuts against the second connecting body.

8. The rail structure according to claim 1, wherein the rail is provided with two rail mounting portions extending outwardly therefrom, and each of the rail mounting portions defines a groove area with other portions of the body.

9. The rail structure according to claim 8, wherein the rail mounting portion is provided with a first protrusion and a second protrusion, and a recessed area is defined between the first protrusion and the second protrusion.

10. The rail structure according to claim 1, further comprising a plurality of lampshade ring units detachably provided on the body.

11. The rail structure according to claim 1, further comprising the light guide plate, wherein the light guide plate comprises a light guide body and defines two sliding grooves on the light guide body, and the light guide plate is movably mounted on the body via the two sliding grooves and covers the opening position;
the light guide body has a light outgoing flat surface, a light outgoing curved surface, or a light composite surface; wherein the light composite surface is formed by at least two light outgoing flat surfaces, formed by at least two light outgoing curved surfaces, or formed by at least one light outgoing flat surface and at least one light outgoing curved surface;
the light guide body is provided with an extending end portion extending from a side thereof away from the rail.

12. A rail lighting structure, comprising a conductive input connector, a connecting body, a conductive switch, a rail, a light source, and a light guide plate;
wherein the rail comprises a body and a light outgoing area formed by the body;
the body further defines an opening position in communication with the light outgoing area, and the opening position is located at a light emitting direction of the light outgoing area, the light guide plate is located in the body and covers the opening position;
the light source is located in the body, and the light source emits light towards the light outgoing area and the opening position;
the connecting body comprises a first connecting body and a second connecting body, the first connecting body and the second connecting body are both located on the body and are electrically coupled to an anode circuit and a cathode circuit, respectively;
the conductive input connector is partially inserted into the body, and comprises a connecting portion, the connecting portion comprises a first connecting portion and a second connecting portion, the first connecting portion abuts against the first connecting body, and the second connecting portion abuts against the second connecting body;
the conductive switch comprises a connecting end, the connecting end comprises a first connecting end and a second connecting end, the first connecting end is connected to the first connecting body, and the second connecting end is connected to the second connecting body.

13. The rail lighting structure according to claim 12, wherein the number of the first and the second connecting body are both two, and each side of two inner sides of the body is provided with a set of the connecting body, each set of the connecting body comprises one first connecting body and one second connecting body.

14. The rail lighting structure according to claim 12, wherein the body of the rail is an aluminum profile, and the first connecting body and the second connecting body are both insulated from the body.

15. The rail lighting structure according to claim 12, wherein the conductive switch has a casing and a switching portion located in the casing, the connecting end is provided with an elastic portion and a connecting portion, an end of the connecting portion is exposed outside the casing, the elastic portion is at least partially located between another end of the connecting portion and the switching portion, one end of the connecting portion abuts against the connecting body and applies a force to the elastic portion, such that the elastic portion is deformed and the another end of the connecting portion abuts the switching portion.

16. The rail lighting structure according to claim 15, wherein the switching portion further comprises a manual switch knob or a wireless receiving module configured to control the conduction of the conductive switch.

17. The rail lighting structure according to claim 12, wherein the conductive switch is fully located in the body; or the conductive switch is slidably located in the body and is partially located outside the body.

18. The rail lighting structure according to claim 12, further comprising a lighting device slidably located in the body and is partially located outside the body.

19. The rail lighting structure according to claim 12, wherein the first connecting body and the second connecting body are both inserted on the body.

20. The rail lighting structure according to claim 12, wherein the rail further has a first mounting area and a second mounting area formed by the body, respectively; at least two first protruding portions are extended from the body at the first mounting area, and at least two second protruding portions are extended from the body at the second mounting area; the first connecting body is located at the first mounting area and abuts against the at least two first protruding portions, and the second connecting body is located at the second mounting area and abuts against the at least two second protruding portions;
the first mounting area and the second mounting area are in communication with the light outgoing area, respectively;
the first connecting body comprises a first insulating abutting portion and a first conductor, the first insulating abutting portion defines a first mounting groove, and an extending direction of the first mounting area is the same as the extending direction of the rail, the first insulating abutting portion is located at the first mounting area and abuts against the at least two first protruding portions, the first conductor is located in the first mounting groove and is partially exposed outside the first mounting groove, and an extending direction of the exposed portion of the first conductor is the same as an extending direction of the rail;
the second connecting body comprises a second insulating abutting portion and a second conductor, the second insulating abutting portion defines a second mounting groove, and an extending direction of the second mounting area is the same as the extending direction of the rail, the second insulating abutting portion is located at the second mounting area and abuts against the at least two second protruding portions, the second conductor is located in the second mounting groove and is partially exposed outside the second mounting groove, and an extending direction of the exposed portion of the second conductor is the same as the extending direction of the rail;
the first insulating abutting portion buts against the body and defines at least two gap areas with the body at the first mounting area, and the second insulating abutting portion buts against the body and defines at least two gap areas with the body at the second mounting area.
